(19) United States
(12) Patent Application Publication
(10) Pub. No.: US 2008/0033908 A1
(43) Pub. Date: Feb. 7, 2008

(54) Method and system for data processing in a shared database environment

(75) Inventors: John Cooper, Kanata (CA); Yair Matas, Ottawa (CA)

Correspondence Address: GOWLING, LAFLEUR & HENDERSON LLP, 160 ELGIN STREET, SUITE 2600, OTTAWA, ON, K1P 1C3, US

(73) Assignee: Nortel Networks Limited

(21) Appl. No.: 11/498,894

(22) Filed: Aug. 4, 2006

(51) Int. Cl. G06F 17/30

(52) U.S. Cl. 707/2

(57) ABSTRACT

A method and system for data processing in a shared database environment is provided. The database entries may be updated or read with parallel processes. The processes on the database entry are classified as non-synchronizing process and synchronizing process. The synchronizing process updates the database entry using data obtained by the non-synchronizing process.

### FIELD OF INVENTION

The present invention relates to data processing technology, and more specifically to a method and system for data processing in a shared-database environment.

### BACKGROUND OF THE INVENTION

With increasing network traffic capacity, there will exist mismatches in processing performance between components in a network device. This becomes a problem when the required throughput of the system is significantly more than the capacity of one particular component. Typically the slower component has more complex functionality such as the management of a database entry. Because of its complexity, the component may have significant memory bandwidth and latency limitations. To solve the drawback, major re-engineering or redesign of the slow component would be required. However, this can be a significant expense, especially for a hardware device such as an Application Specific Integrated Circuit (ASIC).

### SUMMARY OF THE INVENTION

It is an object of the invention to provide a method and system that obviates or mitigates at least one of the disadvantages of existing systems.

According to an aspect of the present invention there is provided a system for data processing in a shared database environment. The system includes: a data frame source for providing data frames; and a configurable data processing device for a plurality of processes operating in parallel on one or more than one database entry in the database, the configurable data processing device for classifying each process as a contributing process or a synchronizing process, the contributing process providing data associated with the data frame, the synchronizing process implementing atomic read and update to the database entry based on the data provided by one or more than one contributing process.

According to a further aspect of the present invention there is provided a method for data processing with a plurality of processes operating in parallel on one or more than one database entry in a database. The method includes the steps of receiving data frames, and classifying each process as a contributing process or a synchronizing process. The contributing process provides data associated with the data frame. The synchronizing process implements atomic read and update to the database entry based on the data provided by one or more than one contributing process.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 is a diagram showing an example of a configurable data processing device in accordance with an embodiment of the present invention;

FIG. 2 is a flow chart showing an example of an operation for the configurable data processing device of FIG. 1;

FIG. 3 is a diagram showing an example of an ingress route switch processor in accordance with an embodiment of the present invention;

FIG. 4 is a diagram showing an example of a policer bucket of FIG. 3;

FIG. 5 is a diagram showing another example of the policer bucket;

FIG. 6 is a diagram showing an example of a policing implementation applied to the ingress route switch processor;

FIG. 7 is a diagram showing an example of policing a plurality of critical sections applied to the ingress route switch processor;

FIG. 8 is a diagram showing an example of a policer bucket record in the ingress route switch processor; and

FIG. 9 is an operation flow diagram showing an example of bucket record updating processes applied to the ingress route switch processor.

### DETAILED DESCRIPTION

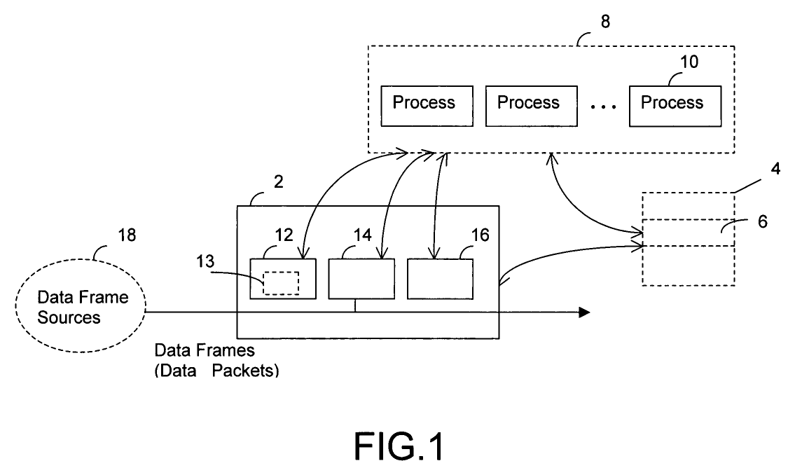

Referring to FIG. 1, a configurable data processing device in accordance with an embodiment of the present invention is described. A device 2 for implementing the configurable data processing regulates data processing associated with a database 4. The configurable data processing device 2 may be implemented by any hardware, software or a combination of hardware and software having functions described below.

In FIG. 1, one database 4 is illustrated as an example. However, the configurable data processing device 2 may regulate data processing associated with more than one database.

The database 4 includes at least one readable and updatable database entry 6. The database 4 manages data to be updated, and may include, but not limited to, any type of memory, repository, and storage.

An application 8 includes a plurality of processes 10 in parallel on one or more than one database entry 6, in dependence upon incoming data frames (data packets). For example, the process 10 includes the capability to gain access, read, update, and release access to the database entry 6. The aggregate arrival rate of the data frames may be greater than a single process's database update rate. An atomic operation is one that must be completed in its entirety or not at all. This applies to multiple processes accessing a shared resource where invalid results would occur if a process was interrupted during an operation on the shared resource. The configurable data processing device 2 ensures atomic read and update of database entries with the parallel processes 10 where the aggregate arrival rate of the data frames is greater than a single process's database update rate.

The configurable data processing device 2 includes a module 12 for atomic read and update to a shared database. In the example, the module 12 includes a counting semaphore “a”, labeled as 13 in FIG. 1. The counting semaphore “a” is a semaphore for managing a pool of resources. The count of the counting semaphore “a” maps to the number of resources available. Processes are given access to the resources until the count indicates that no more resources are available. At this point a process would become blocked. As processes free resources, the count is updated to reflect this result. The count is an integer variable. In the description below, “the count” and “the counting semaphore” are used interchangeably.

The counting semaphore “a” is initialized for the database entry 6, and atomically incremented or decremented by the process 10. In FIG. 1, the counting semaphore “a” is provided in the configurable data processing device 2. However, the counting semaphore “a” may be provided separately from the configurable data processing device 2. Further, more than one counting semaphore may be provided to each database entry 6.

In one example, the “update (updating)” includes a non-trivial function of (1) the database entry's current state and (2) the state of the updating process. The non-trivial function is a function more complex than a single operator mathematical function, such as add or multiply. The next state of the updating process is dependent on (3) the new state of the database entry 6. For example, the process state and database entry's state may be stored in a record 16.

The configurable data processing device 2 reduces the average amount of time needed by the process to gain access, update, and release access to the database entry 6. Instead of having each updating process update the database entry 6 directly, the updating process will be assigned the role of either a synchronizing process or a contributing process.

The module 12 restricts access to the shared resource, i.e., database entry 6, and allows the processes 10 to enter their critical sections. If one synchronizing process is executing in its critical section for a specific database entry, then no other processes can access that database entry.

The contributing process is a process that provides new data to update the database entry 6, however which does not implement the updating itself. This process is also referred to as a non-synchronizing process. It is noted that in this description, “contributing (process/thread)” and “non-synchronizing (process/thread)” may be used interchangeably.

The synchronizing process is a process that provides new data to update the database entry 6 and which also collects data from one or more than one contributing processes. The synchronizing process is responsible for amalgamating all new data into a single database update. Only synchronizing processes will update the database entry 6, after collecting data from contributing processes.

The contributing process stores updates and waits for the synchronizing process to read the database entry 6; the synchronizing process performs a function on behalf of the contributing process, updates the database entry 6, and communicates the result to the contributing process. The function performed by the synchronizing process may include, but not limited to, data throughput policing and metering, financial transaction processing and telemetry processing,

For example, one set of slots is configured per database entry for its updating. In dependence upon data frames, the contributing processes store data within a slot in a data record 14. The synchronizing process collects data from the data record 14 and updates the database entry 6. The record of the state 16 is updated during the process.

In FIG. 1, the data record 14 is shown in the configurable data processing device 2. However, the data record 14 may be provided separately from the configurable data processing device 2. The data record 14 may be in the database 4.

In FIG. 1, the state record 16 is shown in the configurable data processing device 2. However, the state record 16 may be stored outside the configurable data processing device 2. The state record 16 may be in the database 4.

The configurable data processing device 2 is provided to, for example, a telecommunications network. The data frames (or packets) from a data frame source 18 may be, but not limited to, Ethernet packets over Asynchronous Transfer Mode (ATM). The system of FIG. 1 may be provided to telecommunications networks that provide Ethernet virtual line services (EVLS). However, the embodiment of the present invention is applicable to any communications networks, other than, telecommunications networks, such as ATM networks, EVLS networks.

Access to the database entry 6 is controlled by the counting semaphore “a” and is set to 1 on initialization of the system. For the updating of a specific database entry 6, a ratio of synchronizing processes to contributing processes is initially configured such that contributing processes: synchronizing processes=b: 1 (b: positive integer). For example, the configurable data processing device 2 supports 4 contributing processes (i.e., b=4) to 1 synchronizing process. Each of all processes that will access a particular database entry obtain a unique number “c”, sequenced on their activation.

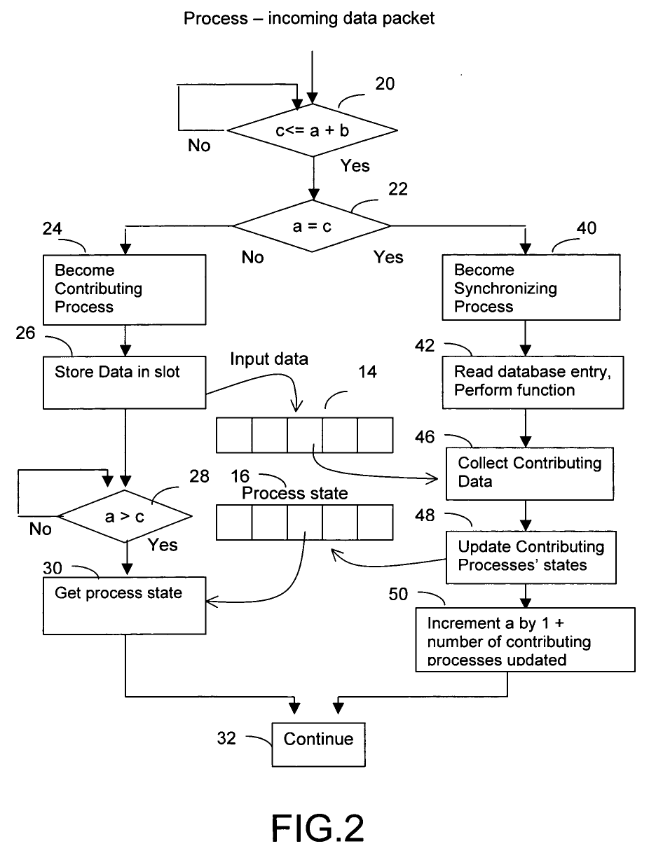

FIG. 2 illustrates an example of an operation of the configurable data processing device 2. Referring to FIG. 2, when a process attempts to update the database entry 6, it will wait until c<=a+b (step 20).

When c<=a+b and a≠c, the process will be classified as a contributing process (steps 22 and 24). The process stores its data within a slot in the data record 14 (step 26), to be merged into the database entry update. The offset of the slot is based on c. Once it has stored its data, it waits until a>c (step 28).

If a=c, the process will is classified as a synchronizing process (steps 22 and 40). The process reads the database entry, performs a function, related to its state, on the data of the database entry 6 (step 42). It then collects data from the slots of contributing processes (step 44). The database entry 6 is updated after collecting the contributing data. The slots are cleared as they are read. The collection of data is implemented until an empty slot is found. The contributing processes' states in the state record 16 are updated (step 46).

Contributing processes waiting for a condition of a>c (step 28) may now proceed (step 32), after reading their new state (step 30).

After updating the contributing processes' states, “a” will be incremented by 1+the number of contributing processes updated (step 48). Then it goes to step 32. Processes may still need to perform additional work. This is independent of their status as a contributing or synchronizing process.

As an example, 9 packets have currently been processed (i.e., c=9). The next arriving packet is handled by a process that will be given a processing number of c+1=10. The system of FIG. 1 is configured to support 4 contributing processes (i.e., b=4). Currently there are 4 contributing processes and 1 synchronizing process in the critical section.

The process in question, having c=10, sees the counting semaphore a=5. Since c>a+b (step 22 of FIG. 2), it cannot continue, and waits. However, once all current processing of the database entry update are done, the synchronizing process having c=5 increments the semaphore by 5 (itself+4 contributing processes). The waiting process now sees a=10 (=c) and thus becomes a synchronizing process (step 40 of FIG. 2).

The configurable data processing device 2 is applicable to any high speed data computation, including but not limited to metering, where data is transmitted or discarded based on its conformance to a pre-determined subscribed rate.

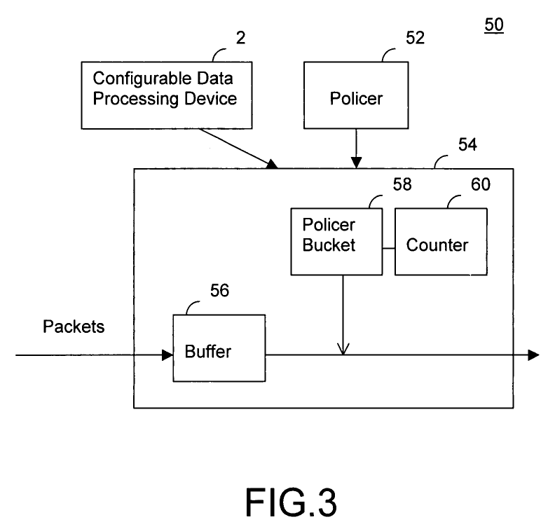

FIG. 3 illustrates an example of an ingress route switch processor 50 in accordance with an embodiment of the present invention where the configurable data processing is implemented. Referring to FIG. 3, the ingress route switch processor 50 includes a policer 52 for discarding packets which would cause its output traffic to exceed a maximum traffic rate or for marking these packets as non-conforming packet rate. A forwarder (not shown) may be integrated into the policer 52, or may be provided separately from the policer 52.

The ingress route switch processor 50 includes a regulator 54. The regulator 54 includes a packet buffer 56 for receiving packets, a policer bucket 58 for regulating the output of the packet buffer 56, and a counter 60 for the policer bucket 58. The counter 60 is used to calculate the data throughput for the policer 52.

The policer bucket 58 contains updatable entries. The configurable data processing 2 regulates updating and reading processes of the policer bucket 58. The updatable entries in the policer bucket 58 are processed through a combination of contributing processes and synchronizing processes.

As shown in FIG. 3, the configurable data processing 2 may be provided separately from the policer 52 and the regulator 54. However, the configurable data processing device 2 may be integrated into the policer 52, the regulator 54, or a combination thereof. It is noted that in the description, “bucket” and “bucket record” may be used interchangeably.

The ingress route switch processor 50 may communicate with an Ethernet interface (not shown) to receive packets. The ingress route switch processor 50 may be a route switch processor for fixed length packet networks, such as ATM. However, the embodiment of the present invention is applicable to any communications systems, other than ATM systems.

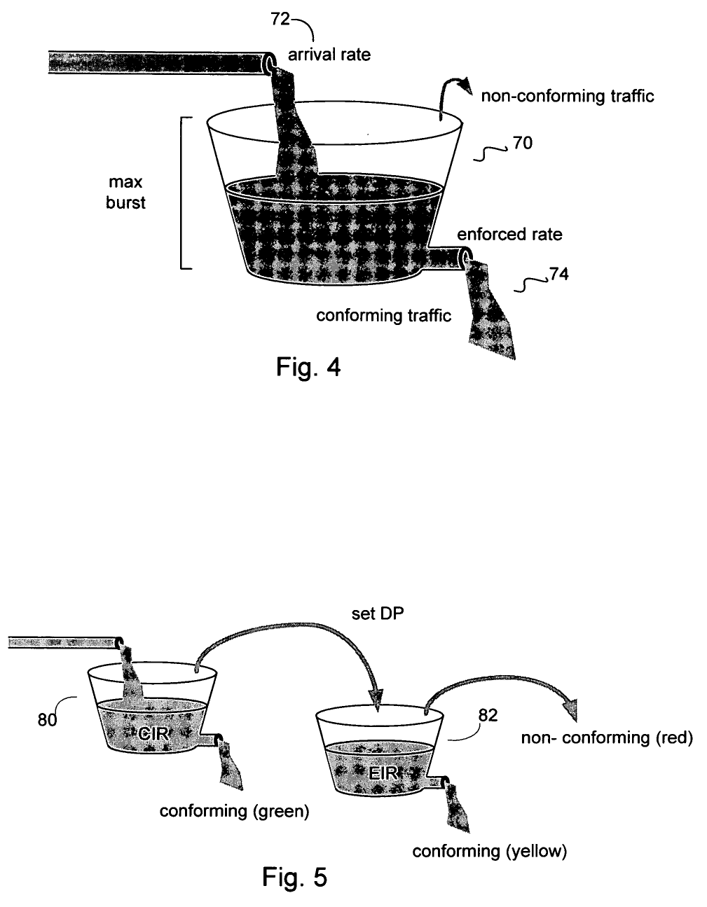

The policing enforces a predetermined traffic rate by dropping or marking non-conforming frames. The policing implementation uses a leaky bucket mechanism as shown in FIGS. 4 and 5. FIG. 4 illustrates an example of the policer bucket 58 of FIG. 3. Referring to FIG. 4, a leaky bucket 70 fills at an arrival rate 72 of packets and leaks at a rate set as an enforced rate 74. The size of the bucket 70 determines the maximum burst rate. In FIG. 4, one leaky bucket 70 is shown as an example of the policer bucket 58 of FIG. 3. However, a plurality of leaky buckets may be served as the policer bucket 58 of FIG. 3. FIG. 5 illustrates a further example of the policer bucket 58 of FIG. 3. In FIG. 5, two leaky buckets 80 and 82 are combined to allow for a Committed Information Rate (CIR) and Extended Information Rate (EIR) policers (e.g., 52 of FIG. 3). In this case, a counter (e.g., 60 of FIG. 3) is provided for each leaky bucket. Non-conforming CIR traffic has drop precedence (DP) marked to, for example, three otherwise DP remains the value from a forwarding record. In FIG. 5, CIP and EIR are shown as examples of traffic parameters, and these may be associated with the Ethernet service frame, based on the selected QoS class. Any other parameters may be used to provide Ethernet services.

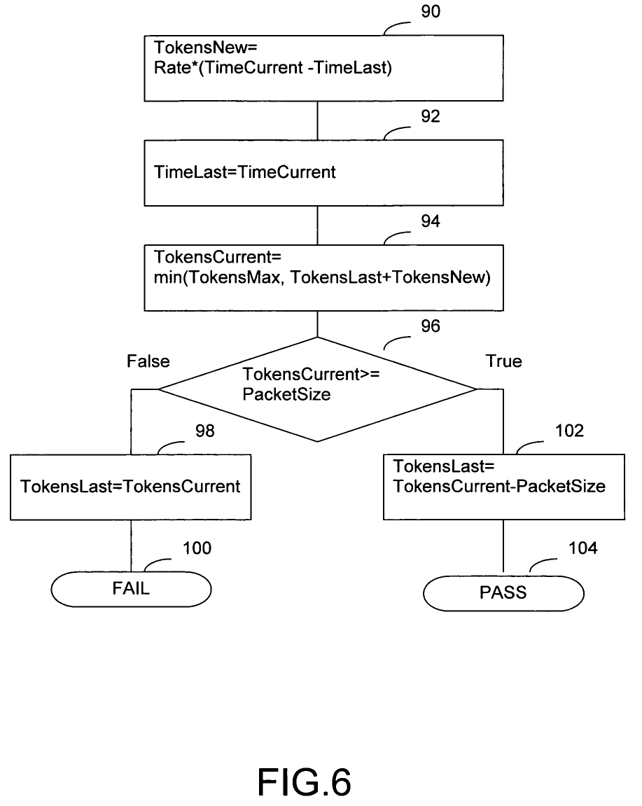

FIG. 6 illustrates an example of basic policing implementation applied to the ingress route switch processor 50 of FIG. 3. The same algorithm can be used for both policer buckets 80 and 82 of FIG. 5.

The operation flow of FIG. 6 is the basis for determining if the rate of incoming data frames exceeds a pre-determined rate (call it “R”). For this determination, tokens are assigned based on the predetermined rate and are consumed as frames arrive. The amount of tokens assigned is inversely proportional to the actual rate of arrival, based on the formula: new tokens=R×(time delta) (step 90). The time delta is found by storing a timestamp for the previous frame's arrival, TimeLast, and subtracting this from the current frame's arrival time, TimeCurrent. The previous frame's arrival time is updated by the current frame's arrival time such that TimeLast=TimeCurrent (step 92). The total number of tokens, as per the specification, is limited, and thus the current number of tokens, TokensCurrent, is taken as the minimum value of the calculated number of tokens, TokensLast+TokensNew, and the maximum number of tokens, TokensMax (step 94). The maximum number of tokens, TokensMax, is equivalent to the bucket size.

A frame is discarded if its size, PacketSize, is greater than the current number of tokens, TokensCurrent (steps 96, 98, 100). The number of tokens that has been assigned to the frames, TokensLast, is: TokensLast=TokensCurrent (step 98). If it is discarded, these tokens have not been consumed.

If the frame is not discarded (i.e., it is conforming), the number of tokens is decremented by the size of the frame, PacketSize. Thus, TokensLast=TokensCurrent-PacketSize (steps 102, 104).

The policer bucket 58 of FIG. 3 may include a policer bucket record for storing TokensNew, TimeCurrent, TimeLast, TokensCurrent, TokensMax, TokensLast, and PacketSize.

Critical Sections in the policing implementation is now described in detail. The policing critical sections are carried out for policing to allow multiple threads to access and update one policer bucket record (e.g. 58 of FIG. 3, 70 of FIG. 4, 80 or 82 of FIG. 5). For example, Last Timestamp and Last Token values (e.g., TimeLast and TokensLast of FIG. 6) are read and updated for a policing bucket calculation. To minimize the period of the critical sections and thus to meet data throughput requirements, there are separate critical sections for the timestamp and the token fields. The data throughput requirements include, for example, highest possible data throughput rate on a data port. These fields are also kept in different words so that they can be updated independently.

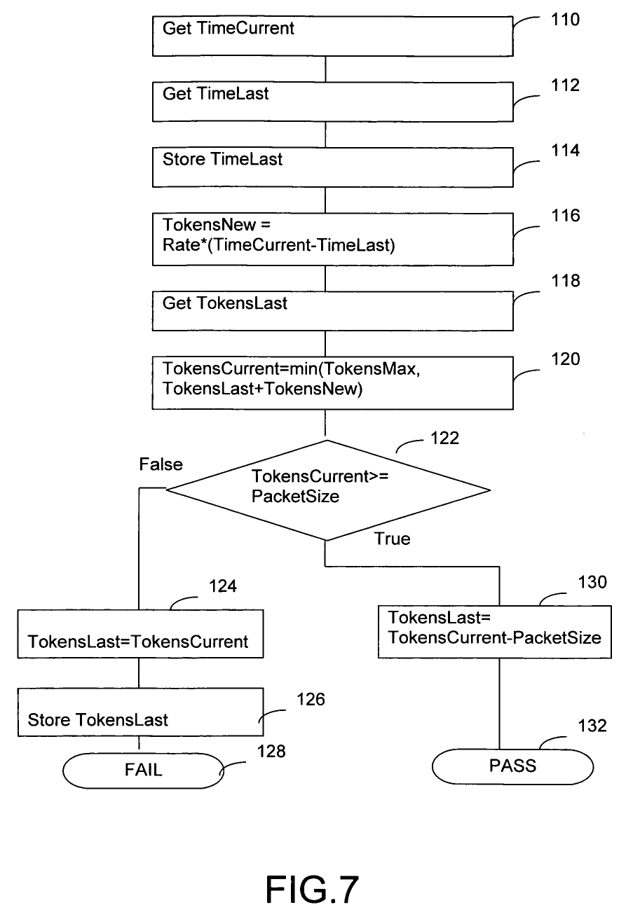

FIG. 7 illustrates an example of policing a plurality of critical sections, applied to the system 50 of FIG. 3. The operation flow of FIG. 7 corresponds to FIG. 6, and is for two critical sections where atomic updates are required. TimeCurrent is obtained (step 110). TimeLast is obtained (step 112). TimeLast is stored (step 114). TokensNew is calculated (step 116) in a manner similar to that of step 90 of FIG. 6. The stored TokensLast is obtained (step 118). TokensCurrent is calculated (step 120) in a manner similar to that of step 94 of FIG. 6. The frame size is examined (step 122) in a manner similar to that of step 96 of FIG. 6.

The frame is discarded if its size, PacketSize, is greater than the current number of tokens, TokensCurrent (steps 122, 124, 126, and 128). TokensLast=TokensCurrent (step 124), and TokensLast is stored (step 126).

If the frame is not discarded (i.e., it is conforming), the number of tokens is decremented by the size of the frame, PacketSize (steps 130, 132) in a manner similar to that of step 102 of FIG. 6.

In FIG. 7, the last timestamp TimeLast is updated atomically (step 114) so that the gap between arriving frames can be determined without error. Also, the token level TokensLast is updated (step 126) atomically as this is a fundamental principle of policing in this example.

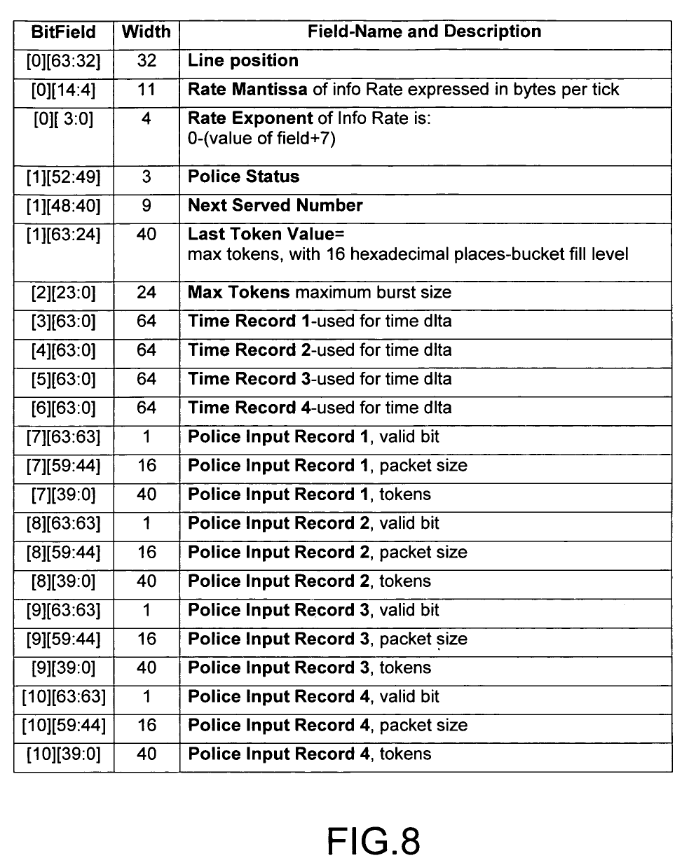

FIG. 8 illustrates an example of the policer bucket record. The policer bucket record of FIG. 8 includes a plurality of fields, such as Line position, Rate mantissa, Rate exponent, Police status, Next served number, Last token value, and Max tokens. The policer bucket record of FIG. 8 further includes Time record N, a valid bit for Police input record N, packet size for Police input record N, and tokens for Police input record N. N is an integer and may be 1≦N≦4.

For example, TokensLast of FIGS. 6 and 7 is stored in “Last Token Value” field. TimeLast of FIGS. 6 and 7 is stored in “Time Record N” field. TokensMax of FIGS. 6 and 7 is associated with “Max Tokens” field.

The policer bucket record may include the starting point for all policing performed.

Further, the police bucket record may include CIR bucket record pointer, CIR bucket counts pointer, EIR bucket record pointer, and EIR bucket counts pointer. The CIR and EIR records may have the same format. A value of zero for the rate mantissa for this bucket, may indicate that all frames will be treated as non-conforming and that the Max Tokens value will be ignored. To handle time delta calculation at line rate, the counter is used for each incoming packet that determines what time slot (one of 4) is used to store the time record. The 4 slots guarantee that a time value will not be over written before the thread has finished processing. Time delta is calculated by subtracting previous slot's time from the current slot's time.

The added difficulty with the critical section is that it should handle the required data throughput by completing processing with high speed (e.g. nano second order). In the embodiment of the present invention, a synchronizing thread approach is used for processing one packet at a time and updating the token level, rather than using external memory. This reduces the number of memory accesses to external memory.

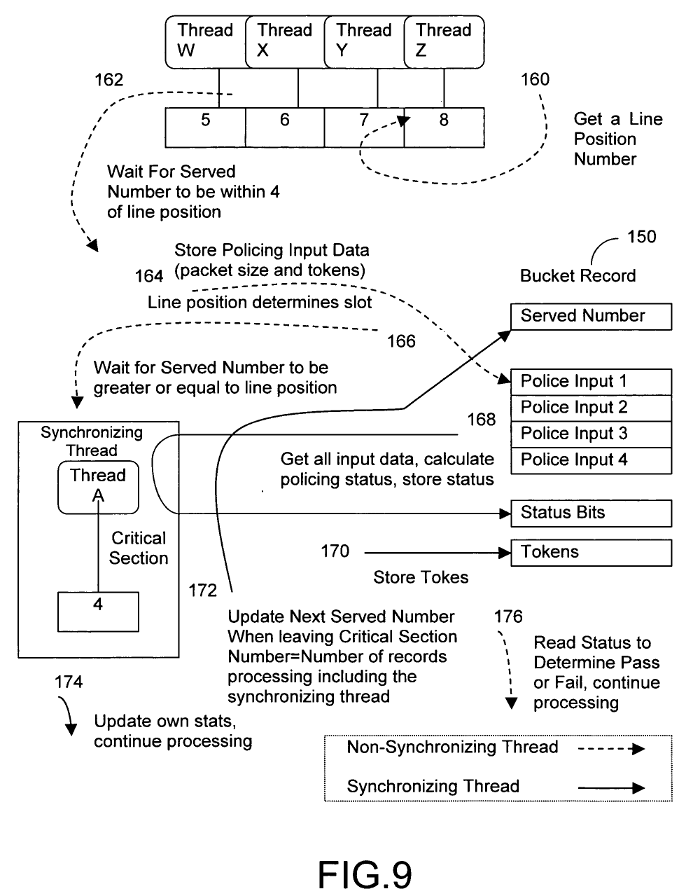

FIG. 9 illustrates an example of the bucket record updating process. Referring to FIG. 9, a plurality of threads “A”, “W”, “X”, “Y”, and “Z” are accessible to a bucket record 150. In this example, “a”, “b”, and “c” in FIG. 2 are as follows: “a”=Served Number (the number that will determine when access to the critical section is allowed), “b”=4 (there are 4 police input slots), and “c”=Line Position.

The line position number (or line position) represents the number of packets that have been processed, at the time that a thread is initialized. It is a unique value assigned to a thread and is used to determine access to the critical section. In FIG. 9, the line position numbers “5”, “6”, “7”, and “8” are shown for the threads “W”, “X”, “Y”, and “Z”, respectfully, and “4” is shown for thread “A”.

One synchronizing thread will update the token count (e.g., 60 of FIG. 3) for up to, for example, 4 other threads. The non-synchronizing threads “W”, “X”, “Y”, and “Z” are those that are within 4 of the served number.

At first a line position number is obtained from the bucket record 150 (step 160). The threads “W”, “X”, “Y”, and “Z” wait for the served number to be within 4 of the line position (step 162). The non-synchronizing threads store police input data (e.g., their packet size and tokens) into a slot, e.g., police input 1, 2, 3 or 4, (step 164), and then wait for the synchronizing thread to update a status, e.g. status bits. The line position determines the slot. “Police input 1”, . . . , and “Police input 4” correspond to “Police Input Record 1”, . . . , and “Police Input Record 4” of FIG. 8.

When the served number exceeds their line position, they know they have been served. The synchronizing thread A at step 166 first determines its policing status and then reads the input records for the other threads (step 168). It continues to read these records until it finds an empty slot or has processed 4 other threads. The synchronizing thread updates the status bits (step 168). Then tokens are stored (step 170). The next served number in the bucket record is updated when leaving critical section number=number of records processing including the synchronizing thread (step 172).

The synchronizing thread updates own status, and continues processing (step 174). The non-synchronizing thread reads the status to determine pass or fail, and continues processing (step 176).

In this example, the new token level, the status of the threads and the line position are all updated in one database write instruction.

According to the embodiments of the present invention, a process/thread is assigned to a role of a contributing or a synchronizing process/thread. Thus, the embodiments of the present invention meet incoming data rates, without redesigning or reconfiguring components.

The embodiments of the present invention provides a generic toolkit for implementing data processing, such as traffic policing and other applications, in software, hardware or a combination thereof, and is not tied into any particular policing algorithm such as those specified in IEFT or MEF drafts. While the embodiment of the present invention is used for policing there is no restriction on what algorithms could be used with it. As such, the embodiment of the present invention by itself is not tied to any standards.

As standards evolve the embodiments of the present invention, unlike policer algorithms implemented in hardware, can adapt to meet their requirements.

The embodiment of the present invention may be applicable to any system using database, such as financial processing from remote sites such as automated banking, real time military command and control systems.

The data processing in accordance with the embodiment of the present invention may be implemented by any hardware, software or a combination of hardware and software having the above described functions. The software code, instructions and/or statements, either in its entirety or a part thereof, may be stored in a computer readable memory. Further, a computer data signal representing the software code, instructions and/or statements, which may be embedded in a carrier wave, may be transmitted via a communication network. Such a computer readable memory and a computer data signal and/or its carrier are also within the scope of the present invention, as well as the hardware, software and the combination thereof.

The present invention has been described with regard to one or more embodiments. However, it will be apparent to persons skilled in the art that a number of variations and modifications can be made without departing from the scope of the invention as defined in the claims.

What is claimed is:

1. A system for data processing in a shared database environment, comprising:
a data frame source for providing data frames; and
a configurable data processing device for a plurality of processes operating in parallel on one or more than one database entry in the database, the configurable data processing device for classifying each process as a contributing process or a synchronizing process, the contributing process providing data associated with the data frame, the synchronizing process implementing atomic read and update to the database entry based on the data provided by one or more than one contributing process.

2. A system as claimed in claim 1, wherein when one synchronizing process is executing in its critical section for the database entry, the configurable data processing device prohibits the other processes from accessing that database entry.

3. A system as claimed in claim 1, wherein the synchronizing process amalgamates data from the one or more than one contributing process into a single database update.

4. A system as claimed in claim 1, wherein the configurable data processing device allows a process to implement the behavior of the contributing process or the synchronization process.

5. A system as claimed in claim 1, wherein the configurable data processing device includes a module for determining a state of update operation, and wherein the configurable data processing device allows a process to implement the behavior of the contributing process or the synchronization process in dependence upon the state.

6. A system as claimed in claim 5, wherein the configurable data processing device includes a counting semaphore “a” that is atomically incremented or decremented by the process, and wherein the state of update operation is determined in dependence upon “a”.

7. A system as claimed in claim 6, wherein the configurable data processing device allocates contributing processes and synchronizing processes at the rate of b: 1 where “b” is a positive integer, and wherein each process has an identification number “c”, and wherein the state of update operation is determined in dependence upon a combination of “a”, “b” and “c”.

8. A system as claimed in claim 1, wherein the synchronizing process implements reading the database entry, performing a function, updating the database entry based on the data collected from the one or more contributing processes, and communicating the result to the contributing process.

9. A system as claimed in claim 1, wherein the plurality of processes are associated with at least one database related operation including policing and metering, financial transaction processing and telemetry processing.

10. A system as claimed in claim 9, wherein the database includes a record to be atomically updated.

11. A system as claimed in claim 1, wherein the update includes a non-trivial function of the database entry's current state and the state of the updating process.

12. A system as claimed in claim 1, wherein the aggregate arrival rate of the data frames is greater than a single process's database update rate.

13. A method for data processing with a plurality of processes operating in parallel on one or more than one database entry in a database, comprising the steps of:
receiving data frames; and
classifying each process as a contributing process or a synchronizing process, the contributing process providing data associated with the data frame, the synchronizing process implementing atomic read and update to the database entry based on the data provided by one or more than one contributing process.

14. A method as claimed in claim 13, further comprising the step of:
when one synchronizing process is executing in its critical section for the database entry, prohibiting the other processes for accessing that database entry.

15. A method as claimed in claim 13, further comprising the step of:
in the synchronizing process, amalgamating data from the one or more than one contributing process into a single database update.

16. A method as claimed in claim 13, wherein the classifying step includes the step of:
allowing a process to implement the behavior of the contributing process or the synchronization process.

17. A method as claimed in claim 13, wherein the classifying step includes the steps of:
determining a state of update operation; and
allowing a process to implement the behavior of the contributing process or the synchronization process in dependence upon the state.

18. A method as claimed in claim 17, further comprising the step of:
atomically incrementing or decrementing a counting semaphore “a” by the process,
and wherein the determining step determines the state of update operation in dependence upon “a”.

19. A method as claimed in claim 18, further comprising the steps of:
allocating contributing processes and synchronizing processes at the rate of b: 1 where “b” is a positive integer; and
setting an identification number “c” to each process,
and wherein the determining step determines the state of update operation in dependence upon a combination of “a”, “b” and “c”.

20. A method as claimed in claim 13, further comprising the steps of:
in the synchronizing process,
reading the database entry;
performing a function;
updating the database entry based on the data collected from the one or more contributing processes; and
communicating the result to the contributing process.

21. A method as claimed in claim 13, wherein the plurality of processes are associated with at least one database related operation including policing and metering, financial transaction processing and telemetry processing.

22. A method as claimed in claim 21, further comprising the step of:
implementing atomic read and update of a record in the database.

23. A method as claimed in claim 13, wherein the update includes a non-trivial function of the database entry's current state and the state of the updating process.

24. A method as claimed in claim 13, wherein the aggregate arrival rate of the data frames is greater than a single process's database update rate.
